(19) United States
(12) Patent Application Publication
(10) Pub. No.: US 2008/0115075 A1
(43) Pub. Date: May 15, 2008

(54) METHOD AND SYSTEM FOR PROVIDING DRAG ENABLED DATE AND/OR TIME COMPONENTS

(76) Inventors: Corinne M. Ryan, Westford, MA (US); J. Christopher Hawley, Chelmsford, MA (US)

Correspondence Address: LOTUS AND RATIONAL SOFTWARE;David A. Dagg, Esq., 44 Chapin Road, Newton, MA, 02459, US

(21) Appl. No.: 11/558,174

(22) Filed: Nov. 9, 2006

(51) Int. Cl. G06F 3/00; G06F 3/048

(52) U.S. Cl. 715/769; 715/856

(57) ABSTRACT

A system for providing date and/or time selections that can be applied across multiple operations and/or applications, in which the user is allowed to make complex date and/or time selections through a time selection user interface, where each date and/or time selection may describe multiple date and/or time ranges, and each date and/or time range has its own associated start and end points. The system enables the user to indicate that a date and/or time selection is to be applied to one or more operations, and provides a visual representation of the date and/or time selection that can be moved by the user outside of the date and/or time selection user interface, and over a user interface for a date and/or time dependent operation to be performed. When the date and/or time selection visual representation is moved over the operation user interface, the system enables the user to indicate that the date and/or time range(s) of the date and/or time selection is to be passed to the operation user interface. In response to the user indicating that the date and/or time range(s) of the date and/or time selection is to be passed to the operation user interface, the system inputs the date and/or time range(s) of the date and/or time selection into the operation user interface. The operation can then be performed using the date and/or time range information of the date and/or time selection.

### FIELD OF THE INVENTION

The present invention related generally to computer user interfaces for computer programs, and more specifically to a method and system for providing drag enabled date and/or time components.

### BACKGROUND OF THE INVENTION

Today's computer systems provide users with access to a wide variety of user interfaces, many of which require a user to select a range of dates or times to be used by an underlying computer program to perform an operation. Many different types of computer programs may require a user to select a time or date range to perform certain operations.

When a user makes a time selection indicating a range of dates or times, that selection must often be used for multiple purposes relating to an event the time selection is intended to describe. For example, separate date dependent operations relating to an event such as a business trip or vacation may include purchasing airline tickets, reserving a hotel room, reserving a rental car, and obtaining tickets to events. However, even though the user may want to apply the same date selection to one or more such different operations relating to the same event, existing systems often force the user to separately re-enter the date selection for each operation. The user will accordingly have to open a user interface to perform a first operation, enter the start and end dates for the date selection required by the first date dependent operation user interface, perform the first operation, save the results of the first operation, close the operation interface and/or application for the first operation, open the next operation user interface, enter the same start and end dates again and perform that operation, and so on until all the related operations for the event are performed. Since the same time or date selection steps may have to be repeated for each of the multiple, different operations, excessive mouse clicks or equivalent actions are introduced into the user experience, and user productivity and/or satisfaction decreases. In addition, on top of the user time required by the excessive clicks using such existing systems, the user must typically open a different sub-component of the user interface, within a single or multiple applications, in order to gain access to the time or date selection program component for each operation the time or date selection is applied to. Moreover, in the event that a user must change a time or date selection that was previously applied to multiple operations, the user must remember the operations the selection was applied to. These events can be spread across many applications and the user can spend hours updating the results of each operation to reflect a change in schedule.

Examples of existing systems that have attempted to provide efficient time selection solutions include Microsoft® Outlook®, IBM® Lotus® Notes®, Novel® Groupwise®, and Web applications such as those provided by Travelocity® and Orbitz®. Each of these existing systems provides a way for a user to enter a time selection to be used to perform an operation. However, none of these existing systems enables the user to enter a time selection and then conveniently apply the selection across multiple operations in potentially multiple applications. These existing systems fail to take into account the need for common persistent time selections, and once a selection is made there is no way to recall that specific time selection for a new purpose.

For these reasons, it would be desirable to have a new system for providing time or date selections that can be conveniently applied across multiple time or date dependent operations and/or applications, and that eliminates the excessive user actions, such as mouse clicks or the like, that are required by previous systems to apply a time or date selection across multiple operations.

### SUMMARY OF THE INVENTION

To address the above described and other shortcomings of existing systems, a new system for providing date and/or time selections that can be applied across multiple operations and/or applications is disclosed. In the disclosed system, the user is allowed to make potentially complex date and/or time selections through a date and/or time selection user interface. Each date and/or time selection input from the user may describe multiple date and/or time ranges, each range having its own associated start and end dates and/or times. The disclosed system then enables the user to indicate that the date and/or time selection is to be applied to one or more date and/or time dependent operations. In response to the indication that the date and/or time selection is to be applied to one or more date and/or time dependent operations, the disclosed system provides a visual representation of the date and/or time selection that can be moved by the user outside of the date and/or time selection user interface, and over a user interface for a date and/or time dependent operation to be performed. When the date and/or time selection visual representation is moved by the user over the user interface for a date and/or time dependent operation to be performed, the disclosed system enables the user to indicate that the date and/or time range(s) of the date and/or time selection is to be passed to the date and/or time dependent operation user interface. In response to the user indicating that the date and/or time range(s) of the date and/or time selection is/are to be passed to the date and/or time dependent operation user interface, the disclosed system inputs the date and/or time range(s) of the date and/or time selection into the date and/or dependent operation user interface. For example, in response to such user indication, the start and end times for time range(s) of a time selection are moved by the disclosed system into appropriate fields of a time dependent operation user interface. The time dependent operation can then be performed using the time range information of the time selection. Similarly, in response to user indication of a date selection including one or more date ranges, the start and end dates for the date selection are moved by the disclosed system into appropriate fields of a date dependent operation user interface, and the date dependent operation can then be performed using the date range information.

In a first embodiment, the disclosed system detects when a user clicks on a date and/or time selection user interface region, and then provides a “ghost” representation of the user's date and/or time selection in the user interface. The user can then drag the ghost representation of the date and/or time selection out of the date and/or time selection user interface region, and over a user interface region associated with a date and/or time dependent operation to be performed, for example by holding down a mouse button and moving the mouse to drag the ghost representation within a desktop user interface. When the user drops the ghost representation of the date and/or time selection over the date and/or time dependent operation user interface region, for example by releasing the mouse button while the ghost representation is over the date and/or time dependent operation user interface region, the disclosed system causes the information associated with the time selection to be used to automatically fill in one or more date and/or time user input fields of the date and/or time dependent operation user interface, so that the operation can be performed using the date and/or time selection information.

In another embodiment, the disclosed system operates in response to a user requesting a context menu related to the date and/or time selection user interface region, for example by right clicking over the date and/or time selection user interface region. The disclosed system then provides a date and/or time selection copy menu that allows the user to indicate a target date and/or time format for a user interface to a date and/or time dependent operation that is to be performed using the current date and/or time selection. The disclosed system then stores the current date and/or time selection in the user indicated format, and enables the user to perform a paste operation over an date and/or time dependent operation user interface that causes the date and/or time range information from the date and/or time selection to be pasted into one or more user input fields of the date and/or time dependent operation user interface in the format previously indicated by the user.

The disclosed system may be embodied such that the date and/or time selection user interface and date and/or time dependent operation user interfaces are provided by or within a single application program, or such that the date and/or time selection user interface is provided by program code that is separate from the application or applications providing the date and/or time dependent operation user interfaces. Examples of date and/or time dependent operations that may be performed using the disclosed system include any operation for which one or more ranges of dates and/or times must be entered by the user into a corresponding user interface, including but not limited to calendaring and scheduling operations, hotel reservation operations, car rental reservation operations, flight reservation operations, out of office automatic response operations, and others.

Thus there is disclosed a new system for providing date and/or time selections that can be conveniently applied across multiple date and/or time dependent operations and/or applications, and that eliminates the excessive user actions, such as mouse clicks or the like, that are required by previous systems to apply a date and/or time selection across multiple date and/or time dependent operations.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram showing software and hardware components in an illustrative embodiment;

FIG. 2 is user interface diagram showing user interface display objects generated in a first operational example of an illustrative embodiment of the disclosed system;

FIG. 3 is a user interface diagram showing user interface display objects generated in a second operational example of an illustrative embodiment of the disclosed system;

FIG. 4 is a user interface diagram showing user interface display objects generated in a third operational example of an illustrative embodiment of the disclosed system;

FIG. 5 is a user interface diagram showing user interface display objects generated in a fourth operational example of an illustrative embodiment of the disclosed system involving a complex date and/or time selection;

FIG. 6 is a flow chart illustrating steps performed in an illustrative embodiment of the disclosed system;

FIG. 7 is another flow chart illustrating steps performed in an alternative illustrative embodiment of the disclosed system; and

FIG. 8 is an example of a display object generated by an illustrative embodiment of the disclosed system to enable a user to select a target date and/or time format.

### DETAILED DESCRIPTION OF EXEMPLARY EMBODIMENTS

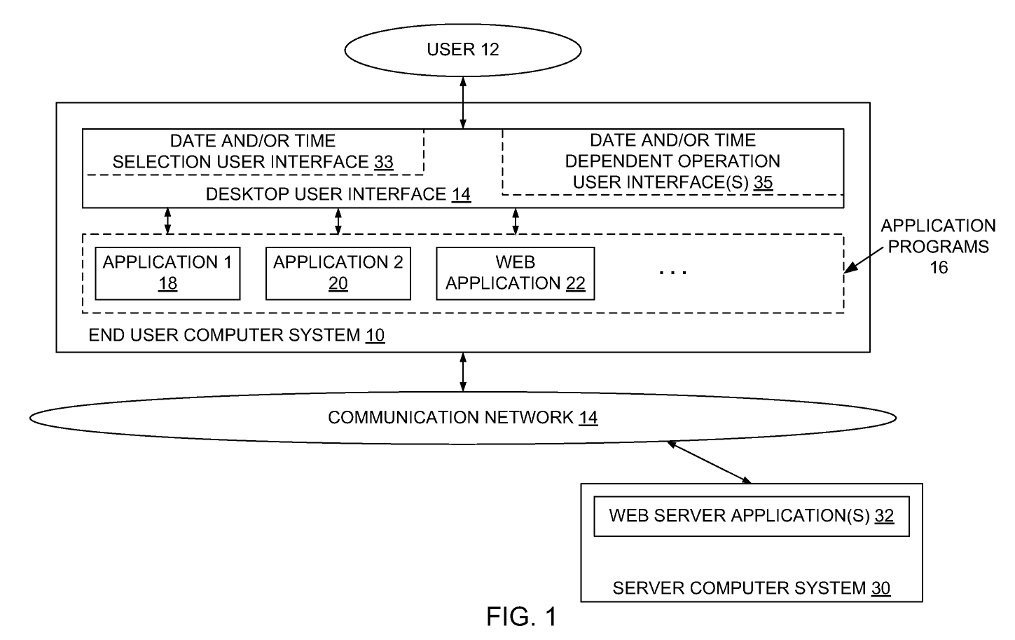

FIG. 1 is a block diagram showing software and hardware components in an illustrative embodiment. As shown in FIG. 1, an end user computer system 10 provides a desktop user interface 14 to a user 12. The desktop user interface 14 includes display regions provided by a number of application programs 16, shown for purposes of illustration including application 1 18, application 2 20, Web application 22, etc. As further shown in FIG. 1, the Web application 22 is an example of an application provided in a client-server model, in which the Web application 22 is the client part, and the server part is shown by Web server application(s) 32 executing in a separate server computer system 30. The server computer system 30 may, for example, be communicably coupled to the computer system 10 by way of one or more data communication network, shown as communication network 14, and consisting of LANs, the Internet, or other types of data communication networks.

During operation of the illustrative embodiment shown in FIG. 1, the disclosed system provides a date and/or time selection user interface 33 and one or more date and/or time dependent operation user interfaces 35. The disclosed system enables the user to make a potentially complex date and/or time selection through the date and/or time selection user interface 33 once, and then conveniently indicate that the date and/or time selection should be applied to one or more of the date and/or time dependent operation user interfaces 35, without having to re-enter the date and/or time selection. The date and/or time selection user interface 33 and date and/or time dependent operation user interface 35 may be provided to the user through the desktop user interface 14 by one or more of the application programs 16, and/or by other program code executing on the computer system 10 and/or server computer system 30.

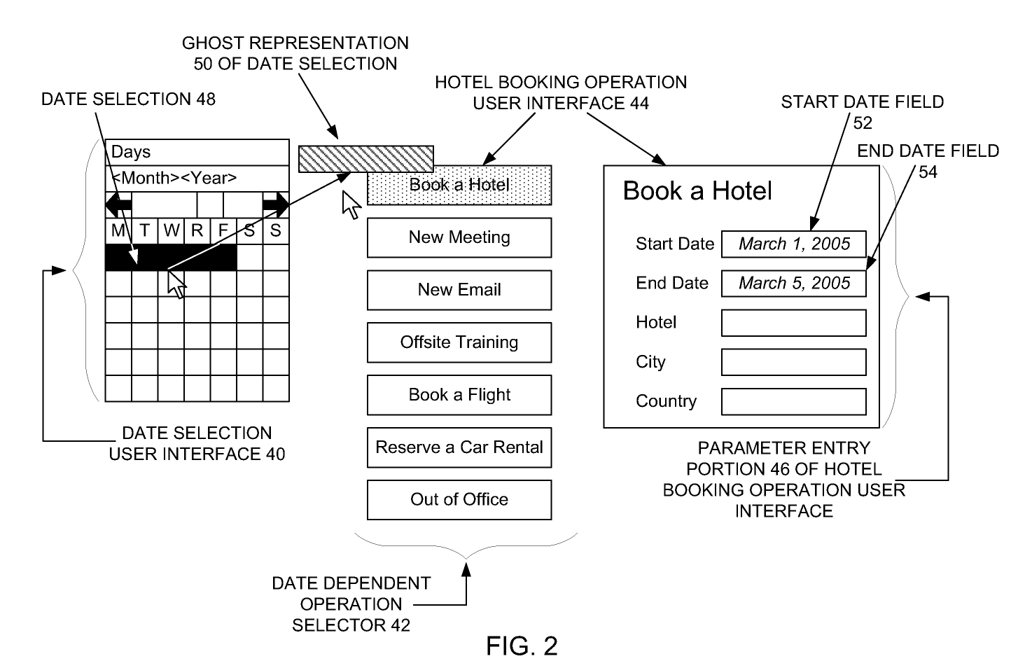

FIG. 2 is user interface diagram showing user interface display objects generated in a first operational example of an illustrative embodiment of the disclosed system. The display objects shown in FIG. 2 may, for example, be part of the desktop user interface 14 shown in FIG. 1. As shown in FIG. 2, an illustrative example of a date and/or time selection user interface is the date selection user interface 40 generated by the disclosed system enables a user to indicate a date selection 48. The date selection user interface 40 is an example of what is sometimes referred to as a “date picker” user interface. The date selection user interface 40 may be embodied in any specific kind of date and/or time selection user interface that allows the user to indicate or select multiple date ranges that are each graphically represented or displayed, for example by the date selection 48, within the date selection user interface 40 in response to the user's indication or selection.

In the example of FIG. 2, the user has clicked on or otherwise selected the darkened boxes in the date selection user interface 40 indicating a date range of Monday through Friday in the first week of a current month displayed in the date selection user interface 40. For example, if the current month in the time selection user interface 40 were March, then the date selection 48 is a graphical representation of the days Mar. 1, 2005 through Mar. 5, 2005.

As further shown in FIG. 2, the disclosed system detects when the user moves the cursor over the date selection 48, clicks and holds on the date selection 48, and then drags the cursor away from the date selection user interface 40, e.g. using a button on a mouse user interface device. In response to detecting that the user has clicked and held on the date selection 48 and/or begun to drag the cursor away from the date selection user interface 40, the disclosed system generates ghost representation 50 of the date selection 48. The ghost representation 50 may be any specific graphical representation of the date selection 48. For example, as shown in FIG. 2, the ghost representation 50 may be a lighter version of the time selection 48, provided in the same shape as the time selection 48.

The disclosed system detects when the user drags the ghost representation 50 over a portion of the hotel booking operation user interface 44. The hotel booking operation user interface 44 is an example of the date and/or time dependent operation user interfaces 35 shown in FIG. 1. In the illustrative embodiment of FIG. 2, the hotel booking operation user interface 44 has a first portion displayed as part of an operation selector 42. The operation selector 42 provides representations of multiple date dependent operations from which the user can select. For example, the user can select a desired operation by dragging the ghost representation 50 over a representation of that operation in the operation selector 42, and then dropping the ghost representation 50 by releasing the mouse button. In the example of FIG. 2, the disclosed system has detected that the user has dragged the ghost representation 50 over the representation of the hotel booking operation in the operation selector 42, which for purposes of explanation is a portion of the hotel booking operation user interface 44 contained in the operation selector 42, and then dropped the ghost representation 50. As a result of detecting that the user has dragged and dropped the ghost representation 50 onto a portion of the hotel booking operation user interface 44, the disclosed system pre-populates the start date field 52 and end date field 54 in the parameter entry portion 46 of the hotel booking operation user interface with date information corresponding to the date selection 48. For example, the start date field 52 is loaded with the date Mar. 1, 2005, and the end date field 54 is loaded with the date Mar. 5, 2005. Thus the user need not re-enter the start date and end date when performing the hotel booking operation, in order to reserve a hotel between the start date and the end date, since those dates have been pre-entered by the disclosed system into the hotel booking user interface 44.

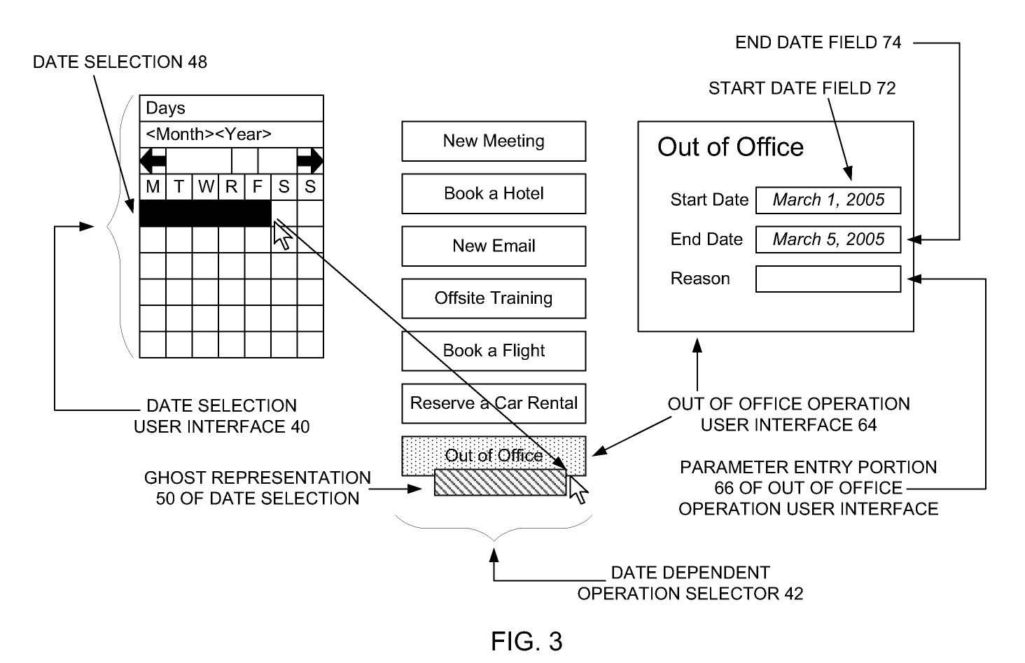

FIG. 3 is a user interface diagram showing user interface display objects generated in a second operational example of an illustrative embodiment of the disclosed system. The display objects shown in FIG. 3 may, for example, be part of the desktop user interface 14 shown in FIG. 1. As in FIG. 2, the date selection user interface 40 enables the user to indicate the date selection 48 (again representing Mar. 1, 2005 through Mar. 5, 2005) by clicking on or otherwise selecting boxes in the date selection user interface 40.

As further shown in FIG. 3, similar to the example of FIG. 2, the disclosed system detects that the user has dragged the ghost representation 50 of date selection 48 over a portion of the out of office operation user interface 64. The out of office operation user interface 64 is another example of the date and/or time dependent operation user interfaces 35 shown in FIG. 1. In the illustrative embodiment of FIG. 3, the out of office operation user interface 64 has a first portion displayed as part of the operation selector 42. In the example of FIG. 3, the disclosed system has detected that the user has dragged the ghost representation 50 over a portion of the out of office operation user interface 64, and then dropped the ghost representation 50. As a result of detecting that the user has dragged and dropped the ghost representation 50 onto a portion of the out of office operation user interface 64, the disclosed system pre-populates the start date field 72 and end date field 74 in the parameter entry portion 66 of the out of office operation user interface with date information corresponding to the previously indicated date selection 48. For example, the start date field 72 has been loaded with the date Mar. 1, 2005, and the end date field 74 has been loaded with the date Mar. 5, 2005. Thus the user need not re-enter the start date and end date when performing an out of office operation, for example to set up an automatically generated out of office reply message in a communication system, since the previously indicated start date and end date have been pre-entered by the disclosed system into the out of office user interface 64.

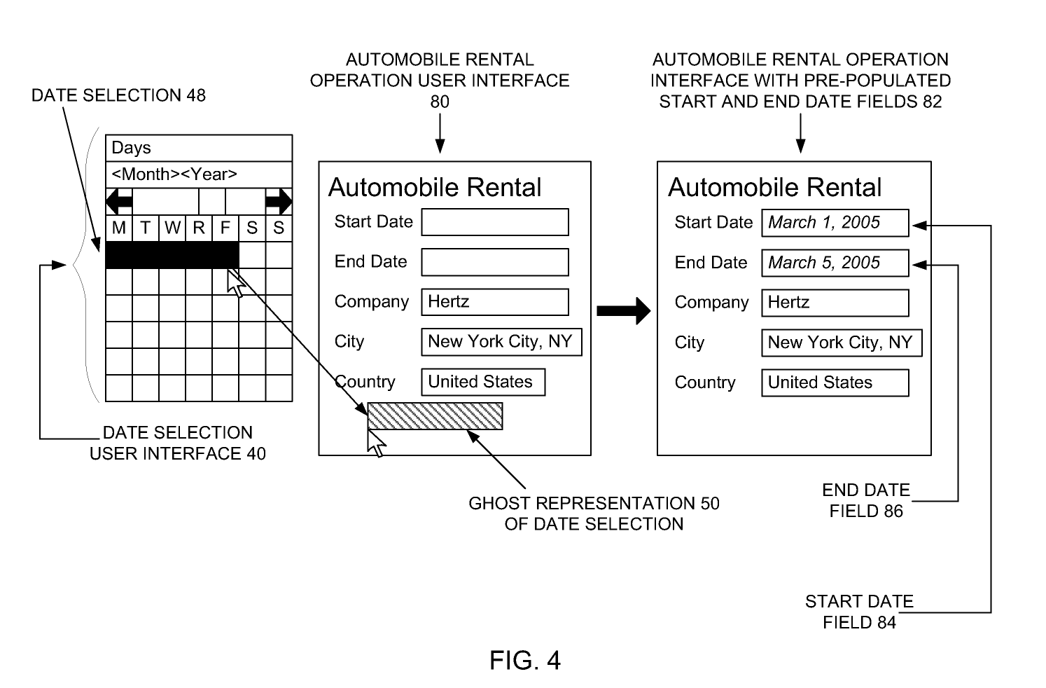

FIG. 4 is a user interface diagram showing user interface display objects generated in a third operational example of an illustrative embodiment of the disclosed system. The display objects shown in FIG. 4 may, for example, be part of the desktop user interface 14 shown in FIG. 1. As in FIGS. 2 and 3, the date selection user interface 40 generated enables the user to indicate the date selection 48 (again representing Mar. 1, 2005 through Mar. 5, 2005) by clicking on or otherwise selecting boxes in the date selection user interface 40. Thus the date selection user interface 40 is an example of a date and/or time selection user interface that enables a user to indicate or select one or more date and/or time ranges that are, for example, graphically displayed as date selection 48 in response to the user's indication or selection. As shown in FIG. 4, the disclosed system detects that the user has dragged the ghost representation 50 of date selection 48 over a portion of the automobile rental operation user interface 80. The automobile rental operation user interface 80 is another example of the date and/or time dependent operation user interfaces 35 shown in FIG. 1. In the illustrative embodiment of FIG. 4, the disclosed system detects that the user has dragged the ghost representation 50 over a portion of the automobile rental operation user interface 80, and then dropped the ghost representation 50. As a result of detecting that the user has dragged and dropped the ghost representation 50 onto a portion of the automobile rental operation user interface 80, the disclosed system pre-populates the start date field 84 and end date field 86 in the updated automobile rental operation user interface 82. The start date field 84 and end date field 86 are pre-populated with date information corresponding to the previously indicated date selection 48. For example, the start date field 84 has been loaded with the date Mar. 1, 2005, and the end date field 86 has been loaded with the date Mar. 5, 2005. Thus the user need not expressly enter the start date and end date when performing an automobile rental operation, for example to set up a car rental between the start date and end date, since the previously indicated start date and end date have been pre-entered into the updated automobile rental operation user interface 82 used by the automobile rental operation.

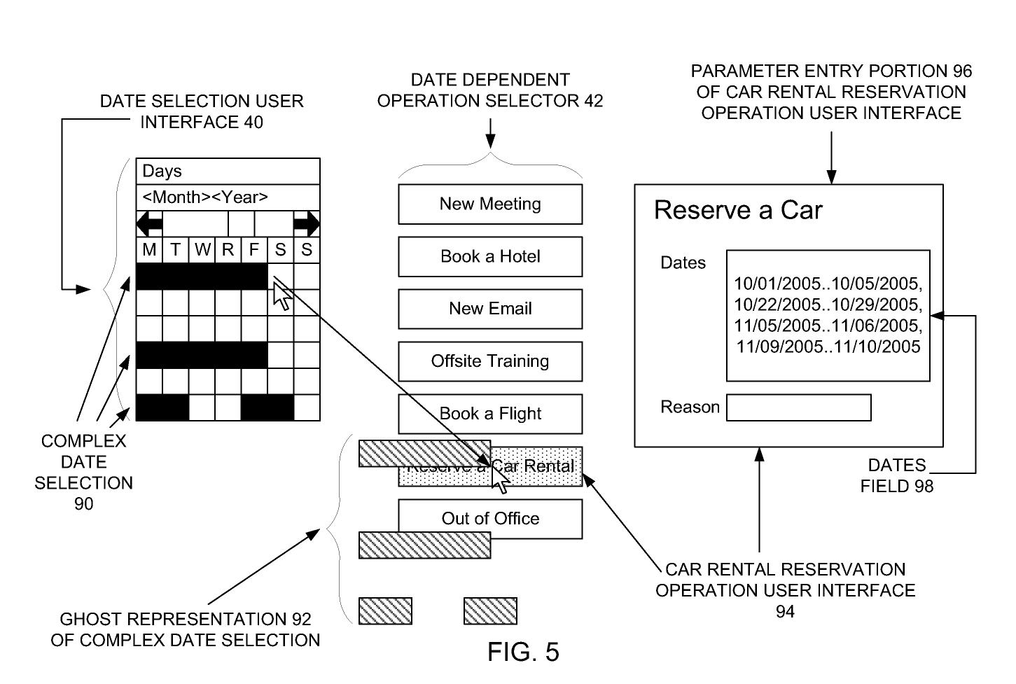

FIG. 5 is a user interface diagram showing user interface display objects generated in a fourth operational example of an illustrative embodiment of the disclosed system involving a complex date and/or time selection. The display objects shown in FIG. 5 may, for example, be part of the desktop user interface 14 shown in FIG. 1. The date selection user interface 40 generated by the disclosed system enables the user to indicate a complex date selection 90 by clicking on or otherwise selecting boxes in the date selection user interface 40. The complex date selection 90 includes multiple date ranges, where each of the date ranges includes a start date and an end date. For example, as shown in FIG. 5, assuming that the date selection user interface 40 currently allows user selection of days going forward from Oct. 1, 2005, the time ranges of the complex time selection 90 are Oct. 1, 2005 through Oct. 5, 2005, Oct. 22, 2005 through Oct. 29, 2005, Nov. 5, 2005 through Nov. 6, 2005, and Nov. 9, 2005 through Nov. 10, 2005.

As further shown in FIG. 5, the disclosed system detects that the user has dragged a ghost representation 92 of complex date selection 90 over a portion of the car rental reservation operation user interface 94. The car rental reservation operation user interface 94 is another example of the date and/or time dependent operation user interfaces 35 shown in FIG. 1. In the illustrative embodiment of FIG. 5, the disclosed system detects that the user has dragged the ghost representation 92 over a portion of the car rental reservation operation user interface 94, and then dropped the ghost representation 92. As a result of detecting that the user has dragged and dropped the ghost representation 92 onto a portion of the car rental reservation operation user interface 94, the disclosed system pre-populates the dates field 98 in the parameter entry portion 96 of the car rental reservation user interface 94. The dates field 98 is pre-populated with date information corresponding to the previously indicated complex date selection 90. For example, the dates field 98 has been loaded with the dates Oct. 1, 2005 through Oct. 5, 2005, Oct. 22, 2005 through Oct. 29, 2005, Nov. 5, 2005 through Nov. 6, 2005, and Nov. 9, 2005 through Nov. 10, 2005, as previously selected by the user through the time selection user interface 40. In the embodiment shown in FIG. 5, the format of the dates loaded into the dates field 98 is known a priori to be MM/DD/YYYY, with start date and end dates for each date range in the complex date selection being separated by “..”, and with each date range separated by a comma (“,”). Accordingly, the illustrative embodiment of FIG. 5 loads the dates field 98 with the pre-selected date ranges in the following format: 10/01/2005..10/05/2005, 10/22/2005..10/29/2005, 11/05/2005..11/06/2005, 11/09/2005..11/10/2005. Thus the user need not re-enter the start dates and end dates when performing car reservation operation, for example to set up a car rental within multiple date ranges in a single operation, since the previously indicated start dates and end dates have been pre-entered into the parameter entry portion 96 of the car rental reservation operation user interface 94.

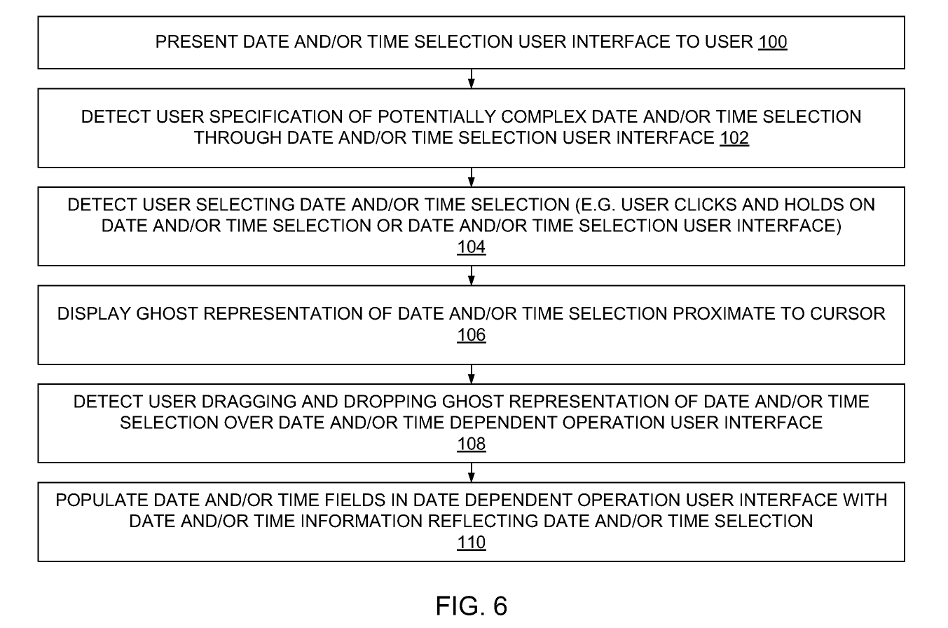

FIG. 6 is a flow chart illustrating steps performed in an illustrative embodiment of the disclosed system. At step 100, the disclosed system operates to present a date and/or time selection user interface to a user. At step 102, the disclosed system detects the user specification of a potentially complex date and/or time selection through the date and/or time selection user interface. At step 104, the user is detected indicating the date and/or time selection specified at step 102, for example when the user presses and holds down the mouse button when the cursor is located over a graphical representation of the date and/or time selection.

At step 106, a ghost representation of the date and/or time selection is displayed to the user in close visual proximity to the cursor in the desktop user interface. At step 108, the disclosed system detects the user dragging and dropping the ghost representation of the date and/or time selection over a date and/or time dependent operation user interface. As a result of the user dragging and dropping the ghost representation of the date and/or time selection onto the date and/or time dependent operation user interface, the disclosed system populates one or more fields in the time dependent operation user interface with date and/or time information reflecting the previously made date and/or time selection, for example including one or more previously selected dates, times, time ranges, date ranges, etc.

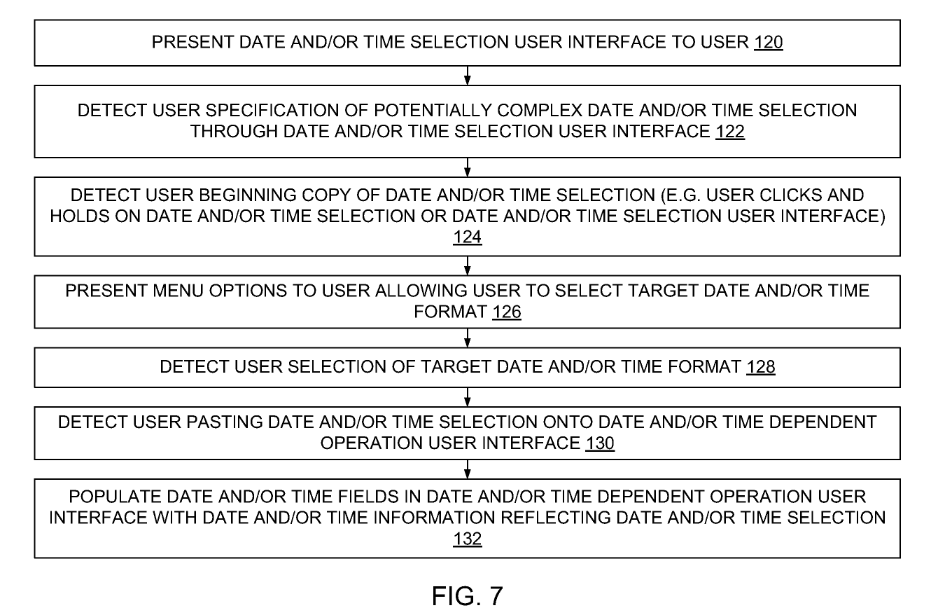

FIG. 7 is a flow chart illustrating steps performed in an alternative illustrative embodiment of the disclosed system. As shown in FIG. 7, at step 120 the disclosed system presents a date and/or time selection user interface to the user, and at step 122 the disclosed system detects a user's specification of a potentially complex date and/or time selection through the date and/or time selection user interface. At step 124, the disclosed system detects a user beginning a copy operation of the date and/or time selection made in step 122. For example, the disclosed system may detect the user performing a right click operation or the like while the cursor is located over the graphical representation of the time selection or over the time selection user interface. In response to the user beginning a copy operation of the time selection, the disclosed system presents menu items at step 126 that allow the user to select a target date and/or time format. A target date and/or time format describes how the date and/or time ranges in the date and/or time selection are to be represented as characters in the fields of the date and/or time dependent operation user interface to which the date and/or time selection is to be copied.

The user may select at step 128 from various specific date and/or time formats displayed as selectable options at step 126. Most such selectable date formats indicate three parts of each represented date: the day of month, month, and the year. The differing formats that may be selected from at step 126 include various specific date formats that are sometimes described in terms of in terms of their “endianness.” For example, various ones of the following types of date formats may be selected from at step 126:

1) Little endian forms, starting with the day. Examples:
16/11/2003, 16.11.2006, 16-11-2003 or 16-11-03
16th of November 2003
16th November 2003
16 November 2003
16 November 2003

2) Big endian forms, starting with the year. Examples:
2003 Nov. 16,
2003-11-16

3) Middle endian forms, starting with the month. Examples:
Nov. 16, 2003
Nov. 16, 2003
11/16/2003, 11-16-2003, 11.16.2003 or 11.16.03

The user selection at step 126 further indicates how the range or ranges of dates and/or times are to be represented when entered into the target user interface of a date or time dependent operation. For example, a selectable target date range format indicated by the user at step 126 may be comma delimited, with “..” denoting a range with a start date followed by the end point for contiguous ranges. This is the same format as used in the example of FIG. 5 in the following date range representation: 10/01/2005..10/05/2005, 10/22/2005..10/29/2005, 11/05/2005..11/06/2005, 11/09/2005..11/10/2005.

After the disclosed system has detected that the user has selected a target date and/or time format at step 128, the disclosed system operates at step 130 to detect the user performing a paste operation of the date and/or time selection onto the date and/or time dependent operation user interface. Such a paste operation may be performed through the user right clicking while the cursor is over the date and/or time dependent operation user interface and clicking on a paste menu item in the resulting menu. At step 132, the disclosed system populates one or more date and/or time fields in the date and/or time dependent operation user interface with date and/or time information reflecting the user's date and/or time selection detected at step 122. The date and/or time fields of the date and/or time dependent operation user interface are populated with date and/or time information in the format selected by the user at step 130.

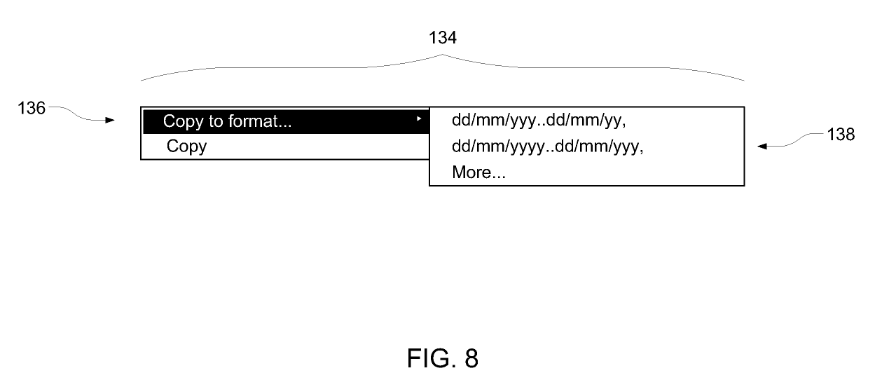

FIG. 8 is an example of a display object 134 generated at step 126 of FIG. 7 by an illustrative embodiment of the disclosed system to enable a user select a target date and/or time format at step 128 of FIG. 7. As shown in FIG. 8, the display object 134 is a portion of a context menu that enables the user to select a “Copy to Format” menu item 136, causing a list 138 of target formats to be presented from which the user can select.

The present invention can be realized in hardware, software, or a combination of hardware and software. A system according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable medium or memory that can direct a computer or other programmable data processing apparatus to function in a particular manner, such that the instructions stored in the computer-readable medium or memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for providing date selections that can be applied across multiple operations, comprising:
providing a date selection user interface to a user, wherein said date selection user interface enables a user to define a date selection indicating at least one date range, wherein said date range includes dates between an associated start date and end date;
obtaining, from said user through said date selection user interface, a user indication that said date selection is to be applied to an operation;
displaying, responsive to said user indication that said date selection is to be applied to said operation, a visual representation of said date selection;
enabling said user to move said visual representation of said date selection over an operation user interface, wherein said operation user interface is external to said date selection user interface;
enabling said user to indicate, while said visual representation of said date selection is located over said operation user interface, that said date selection is to be applied to said operation user interface;
providing said start date and said end date associated with said date range of said date selection to said operation user interface such that an operation associated with said operation user interface can be performed using said start date and end date.

2. The method of claim 1, further comprising:
wherein said date selection indicates a plurality of date ranges, each of said plurality of date ranges having an associated start date and end date; and
wherein said providing said start date and end date associated with said date range of said date selection to said operation user interface includes providing each of said start dates and end dates associated with each of said plurality of date ranges to said operation user interface.

3. The method of claim 2, further comprising:
wherein said visual representation of said date selection is a ghost representation of said date selection displayed adjacent to a cursor display object;
wherein said user indication that said date selection is to be applied to said operation is a mouse click on said date selection user interface;
wherein said enabling said user to move said visual representation of said date selection over an operation user interface includes enabling said user to move said ghost representation of said date selection over said operation user interface; and
wherein said enabling said user to indicate that said date selection is to be applied to said operation user interface includes enabling said user to drop said ghost representation of said date selection over said operation user interface.

4. The method of claim 3, wherein said enabling said user to drop said ghost representation of said date selection over said operation user interface comprises enabling said user to drop said ghost representation of said date selection over said operation user interface by releasing a mouse button while said ghost representation of said date selection is over said operation user interface.

5. The method of claim 4, further comprising:
obtaining, from said user through said date selection user interface, subsequent to performing said operation, and without said user re-entering said date selection, a user indication that said date selection is to be applied to a second operation;
displaying, responsive to said user indication that said date selection is to be applied to said second operation, said visual representation of said date selection;
enabling said user to move said visual representation of said date selection over an operation user interface for said second operation, wherein said operation user interface for said second operation is external to said date selection user interface;
enabling said user to indicate, while said visual representation of said date selection is located over said operation user interface for said second operation, that said date selection is to be applied to said operation user interface for said second operation;
providing said start date and said end date associated with said date range of said date selection to said operation user interface for said second operation such that said second operation can be performed using said start date and end date.

6. The method of claim 1, further comprising:
displaying a first context menu while a cursor is displayed above said date selection user interface, wherein said first context menu includes a date selection copy menu item enabling said user to indicate that said date selection is to be copied to an external user interface, and wherein said date selection copy menu item further enables said user to select a date range format; and
enabling said user to perform a paste operation causing said start date and end date to be pasted into one or more fields of a second operation user interface in said selected date range format.

7. The method of claim 1, wherein said date selection user interface and said operation user interface are provided by separate application programs.

8. The method of claim 1, further comprising:
wherein said date selection comprises a time selection indicating at least one time range, wherein said time range includes times between an associated start time and end time.

9. A system including a computer readable medium, said computer readable medium having program code stored thereon for providing date selections that can be applied across multiple operations, said program code comprising:
program code for providing a date selection user interface to a user, wherein said date selection user interface enables a user to define a date selection indicating at least one date range, wherein said date range includes dates between an associated start date and end date;
program code for obtaining, from said user through said date selection user interface, a user indication that said date selection is to be applied to an operation;
program code for displaying, responsive to said user indication that said date selection is to be applied to said operation, a visual representation of said date selection;
program code for enabling said user to move said visual representation of said date selection over an operation user interface, wherein said operation user interface is external to said date selection user interface;
program code for enabling said user to indicate, while said visual representation of said date selection is located over said operation user interface, that said date selection is to be applied to said operation user interface; and
program code for providing said start date and said end date associated with said date range of said date selection to said operation user interface such that an operation associated with said operation user interface can be performed using said start date and end date.

10. The system of claim 9, further comprising:
wherein said date selection indicates a plurality of date ranges, each of said plurality of date ranges having an associated start date and end date; and
wherein said providing said start date and end date associated with said date range of said date selection to said operation user interface includes providing each of said start dates and end dates associated with each of said plurality of date ranges to said operation user interface.

11. The system of claim 10, further comprising:
wherein said visual representation of said date selection is a ghost representation of said date selection displayed adjacent to a cursor display object;
wherein said user indication that said date selection is to be applied to said operation is a mouse click on said date selection user interface;
wherein said program code for enabling said user to move said visual representation of said date selection over an operation user interface includes program code for enabling said user to move said ghost representation of said date selection over said operation user interface; and
wherein said program code for enabling said user to indicate that said date selection is to be applied to said operation user interface includes program code for enabling said user to drop said ghost representation of said date selection over said operation user interface.

12. The system of claim 11, wherein said program code for enabling said user to drop said ghost representation of said date selection over said operation user interface comprises program code for enabling said user to drop said ghost representation of said date selection over said operation user interface by releasing a mouse button while said ghost representation of said date selection is over said operation user interface.

13. The system of claim 12, said program code further comprising:
program code for obtaining, from said user through said date selection user interface, subsequent to performing said operation, and without said user re-entering said date selection, a user indication that said date selection is to be applied to a second operation;
program code for displaying, responsive to said user indication that said date selection is to be applied to said second operation, said visual representation of said date selection;
program code for enabling said user to move said visual representation of said date selection over an operation user interface for said second operation, wherein said operation user interface for said second operation is external to said date selection user interface;
program code for enabling said user to indicate, while said visual representation of said date selection is located over said operation user interface for said second operation, that said date selection is to be applied to said operation user interface for said second operation; and
program code for providing said start date and said end date associated with said date range of said date selection to said operation user interface for said second operation such that said second operation can be performed using said start date and end date.

14. The system of claim 9, said program code further comprising:
program code for displaying a first context menu while a cursor is displayed above said date selection user interface, wherein said first context menu includes a date selection copy menu item enabling said user to indicate that said date selection is to be copied to an external user interface, and wherein said date selection copy menu item further enables said user to select a date range format; and
program code for enabling said user to perform a paste operation causing said start date and end date to be pasted into one or more fields of a second operation user interface in said selected date range format.

15. The system of claim 9, wherein said date selection user interface and said operation user interface are provided by separate application programs.

16. The system of claim 9, further comprising:
wherein said date selection comprises a time selection indicating at least one time range, wherein said time range includes times between an associated start time and end time.

17. A computer program product including a computer readable medium, said computer readable medium having program code stored thereon for providing date selections that can be applied across multiple operations, said program code comprising:
program code for providing a date selection user interface to a user, wherein said date selection user interface enables a user to define a date selection indicating at least one date range, wherein said date range includes dates between an associated start date and end date;
program code for obtaining, from said user through said date selection user interface, a user indication that said date selection is to be applied to an operation;
program code for displaying, responsive to said user indication that said date selection is to be applied to said operation, a visual representation of said date selection;
program code for enabling said user to move said visual representation of said date selection over an operation user interface, wherein said operation user interface is external to said date selection user interface;
program code for enabling said user to indicate, while said visual representation of said date selection is located over said operation user interface, that said date selection is to be applied to said operation user interface; and
program code for providing said start date and said end date associated with said date range of said date selection to said operation user interface such that an operation associated with said operation user interface can be performed using said start date and end date.

18. A computer data signal embodied in a carrier wave, said computer data signal having program code stored thereon for providing date selections that can be applied across multiple operations, said program code comprising:
program code for providing a date selection user interface to a user, wherein said date selection user interface enables a user to define a date selection indicating at least one date range, wherein said date range includes dates between an associated start date and end date;
program code for obtaining, from said user through said date selection user interface, a user indication that said date selection is to be applied to an operation;
program code for displaying, responsive to said user indication that said date selection is to be applied to said operation, a visual representation of said date selection;
program code for enabling said user to move said visual representation of said date selection over an operation user interface, wherein said operation user interface is external to said date selection user interface;
program code for enabling said user to indicate, while said visual representation of said date selection is located over said operation user interface, that said date selection is to be applied to said operation user interface; and
program code for providing said start date and said end date associated with said date range of said date selection to said operation user interface such that an operation associated with said operation user interface can be performed using said start date and end date.

19. A system for providing date selections that can be applied across multiple operations, comprising:
means for providing a date selection user interface to a user, wherein said date selection user interface enables a user to define a date selection indicating at least one date range, wherein said date range includes dates between an associated start date and end date;
means for obtaining, from said user through said date selection user interface, a user indication that said date selection is to be applied to an operation;
means for displaying, responsive to said user indication that said date selection is to be applied to said operation, a visual representation of said date selection;
means for enabling said user to move said visual representation of said date selection over an operation user interface, wherein said operation user interface is external to said date selection user interface;
means for enabling said user to indicate, while said visual representation of said date selection is located over said operation user interface, that said date selection is to be applied to said operation user interface; and
means for providing said start date and said end date associated with said date range of said date selection to said operation user interface such that an operation associated with said operation user interface can be performed using said start date and end date.
